(19) United States
(12) Patent Application Publication
(10) Pub. No.: US 2013/0345967 A1
(43) Pub. Date: Dec. 26, 2013

(54) ROUTABILITY GRAPH WITH PREDETERMINED NUMBER OF WEIGHTED EDGES FOR ESTIMATING A TRAJECTORY OF A MOBILE DEVICE

(71) Applicant: Payam PAKZAD, San Diego, CA (US)

(72) Inventor: Payam PAKZAD, San Diego, CA (US)

(73) Assignee: QUALCOMM Incorporated, San Diego, CA (US)

(21) Appl. No.: 13/530,005

(22) Filed: Jun. 21, 2012

(51) Int. Cl. G01C 21/34

(52) U.S. Cl. 701/431

(57) ABSTRACT

Various methods, apparatuses and/or articles of manufacture are provided for use in one or more mobile devices to provide positioning based, at least in part, on a routability graph comprising a predetermined number of weighted edges for estimating a trajectory of a mobile device. Various methods, apparatuses and/or articles of manufacture are provided for use in one or more electronic devices to support mobile device positioning based, at least in part, on a routability graph comprising a predetermined number of weighted edges for estimating a trajectory of a mobile device.

### BACKGROUND

1. Field

The subject matter disclosed herein relates to electronic devices, and more particularly to methods, apparatuses and articles of manufacture for use in one or more computing platforms to provide or otherwise support mobile device positioning based, at least in part, on a routability graph comprising a predetermined number of weighted edges for estimating a trajectory of a mobile device.

2. Information

Mobile devices, such as mobile phones, notebook, computers, etc., typically have the ability to estimate location and/or position with a high degree of precision using any one of several technologies such as, for example, satellite positioning systems (e.g., GPS and the like), advanced forward-link trilateration (AFLT), just to name a few examples of signal-based positioning systems and/or corresponding signal signals. Using high precision location information, applications for a mobile device may provide a user with may different services such as, for example, vehicle/pedestrian navigation, location-based searching, just to name a couple of examples. Here, high precision signal-based location information (e.g., obtained from GPS and/or other signal-based positioning systems) may be processed according to a global coordinate system (e.g., latitude and longitude or earth-centered xyz coordinates). While such use of signal-based location information referenced to a global coordinate system may be useful in providing some services (e.g., outdoor vehicle navigation), such signal-based location information referenced to a global coordinate system may be less relevant for other types of services such as indoor pedestrian navigation.

In certain indoor environments, such as office buildings, shopping malls, airports, stadiums, etc., certain example signal-based positioning techniques may make use of various terrestrial-based wireless signal transmitting devices, e.g., wireless network access points, cellular network base stations, special-purpose beacon transmitters, etc., that transmit wireless signals which may be received by the mobile device and used for positioning purposes. For example, a mobile device may receive a signal-based positioning signal from a transmitter and based thereon determine a pseudorange between the transmitter and receiver. Hence, for example, positioning may be provided based on trilateration and/or other known signal-based positioning techniques.

### SUMMARY

In accordance with certain aspects, a method may be provided which comprises, with a mobile device: receiving a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node; affecting a decision of a motion model to transition a state along said at least one edge in estimating a trajectory of said mobile device based, at least in part, on said weight value; and presenting navigation information that is generated based, at least in part, on said trajectory.

In accordance with certain other aspects, an apparatus for use in a mobile device may be provided, which comprises: means for receiving a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node; means for affecting a decision of a motion model to transition a state along said at least one edge in estimating a trajectory of said mobile device based, at least in part, on said weight value; means for generating navigation information based, at least in part, on said trajectory; and means for presenting said navigation information to a user.

In accordance with certain further aspects, a mobile device may comprise: a communication interface; an output unit; and one or more processing units to: receive, via said communication interface, a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node; affect a decision of a motion model to transition a state along said at least one edge in estimating a trajectory of said mobile device based, at least in part, on said weight value; determine navigation information based, at least in part, on said trajectory; and initiate presentation of said navigation information to a user via said output unit.

In accordance with still other aspects, an article of manufacture for use by a mobile device may be provided, which comprises a non-transitory computer readable medium having stored therein computer implementable instructions executable by one or more processing units in said mobile device to: receive a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node; affect a decision of a motion model to transition a state along said at least one edge in estimating a trajectory of said mobile device based, at least in part, on said weight value; determine navigation information based, at least in part, on said trajectory; and initiate presentation of said navigation information to a user via an output unit.

In accordance with certain aspects, a method may be provided which comprises, with at least one computing platform: obtaining a routability graph corresponding to an electronic map of at least a portion of an indoor environment, the routability graph specifying a predetermined number of feasible paths for an object to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; and determining a weight value for at least one edge connected to the at least one node, the weight value being based, at least in part, on a likelihood that an estimated trajectory of the object having reached the at least one node subsequently follows the at least one edge away from the at least one node.

In accordance with certain other aspects, an apparatus may be provided which comprises: means for obtaining a routability graph corresponding to an electronic map of at least a portion of an indoor environment, the routability graph specifying a predetermined number of feasible paths for an object to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; and means for determining a weight value for at least one edge connected to the at least one node, the weight value being based, at least in part, on a likelihood that an estimated trajectory of the object having reached the at least one node subsequently follows the at least one edge away from the at least one node.

In accordance with still other aspects, a device may be provided, which comprises: memory; and one or more processing units to: obtain a routability graph corresponding to an electronic map of at least a portion of an indoor environment, the routability graph specifying a predetermined number of feasible paths for an object to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; and determine a weight value for at least one edge connected to the at least one node, the weight value being based, at least in part, on a likelihood that an estimated trajectory of the object having reached the at least one node subsequently follows the at least one edge away from the at least one node.

In accordance with yet other aspects, an article of manufacture may be provided for use in at least one computing device. Such an article may comprise a non-transitory computer readable medium having stored therein computer implementable instructions executable by one or more processing units of a computing platform to: obtain a routability graph corresponding to an electronic map of at least a portion of an indoor environment, the routability graph specifying a predetermined number of feasible paths for an object to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; and determine a weight value for at least one edge connected to the at least one node, the weight value being based, at least in part, on a likelihood that an estimated trajectory of the object having reached the at least one node subsequently follows the at least one edge away from the at least one node.

In accordance with another aspect, a method may be provided which comprises, with a mobile device: obtaining a routability graph corresponding to an electronic map of at least a portion of an indoor environment, the routability graph specifying a predetermined number of feasible paths to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; obtaining a weight value for at least one edge connected to the at least one node, the weight value representing a predetermined likelihood that an estimated trajectory of an object having reached the at least one node subsequently follows the at least one edge away from the at least one node; and affecting a decision of a motion model to transition a state along the at least one edge in estimating a trajectory of the mobile device based, at least in part, on the weight value.

In accordance with certain further aspects, an apparatus for use in a mobile device. Such an apparatus may comprise: means for obtaining a routability graph corresponding to an electronic map of at least a portion of an indoor environment, the routability graph specifying a predetermined number of feasible paths to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; means for a weight value for at least one edge connected to the at least one node, the weight value representing a predetermined likelihood that an estimated trajectory of an object having reached the at least one node subsequently follows the at least one edge away from the at least one node; and means for affecting a decision of a motion model to transition a state along the at least one edge in estimating a trajectory of the mobile device based, at least in part, on the weight value.

In accordance with certain other aspects, a mobile device may be provided which comprises one or more processing units to: obtain a routability graph corresponding to an electronic map of at least a portion of an indoor environment, the routability graph specifying a predetermined number of feasible paths to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; obtain a weight value for at least one edge connected to the at least one node, the weight value representing a predetermined likelihood that an estimated trajectory of an object having reached the at least one node subsequently follows the at least one edge away from the at least one node; and affect a decision of a motion model to transition a state along the at least one edge in estimating a trajectory of the mobile device based, at least in part, on the weight value.

In accordance with some other aspects, an article of manufacture may be provided for use by a mobile device. Such an article may comprise a non-transitory computer readable medium having stored therein computer implementable instructions executable by one or more processing units in the mobile device to: obtain a routability graph corresponding to an electronic map of at least a portion of an indoor environment, the routability graph specifying a predetermined number of feasible paths to follow within the portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges; obtain a weight value for at least one edge connected to the at least one node, the weight value representing a predetermined likelihood that an estimated trajectory of an object having reached the at least one node subsequently follows the at least one edge away from the at least one node; and affect a decision of a motion model to transition a state along the at least one edge in estimating a trajectory of the mobile device based, at least in part, on the weight value.

In accordance with some further aspects, a method may be provided which comprises, with at least one computing platform: determining one or more feasible paths in a routability graph corresponding to an electronic map for an indoor environment, the routability graph representing a two-dimensional grid comprising edges connecting nodes at angles selected from a predetermined set of discrete angles relative to a datum; and selectively estimating a trajectory of a mobile device along the one or more feasible paths based, at least in part, on a sequence of measurements indicative of one or more positions of the device applied to samples of a probability distribution approximated at least in part using past measurements of positions of devices in the indoor environment.

In accordance with still some other aspects, an apparatus may be provided which comprises: means for determining one or more feasible paths in a routability graph corresponding to an electronic map for an indoor environment, the routability graph representing a two-dimensional grid comprising edges connecting nodes at angles selected from a predetermined set of discrete angles relative to a datum; and means for selectively estimating a trajectory of a mobile device along the one or more feasible paths based, at least in part, on a sequence of measurements indicative of one or more positions of the device applied to samples of a probability distribution approximated at least in part using past measurements of positions of devices in the indoor environment.

In accordance with another aspect, a mobile device may be provided which comprises one or more processing units to: determine one or more feasible paths in a routability graph corresponding to an electronic map for an indoor environment, the routability graph representing a two-dimensional grid comprising edges connecting nodes at angles selected from a predetermined set of discrete angles relative to a datum; and selectively estimate a trajectory of a mobile device along the one or more feasible paths based, at least in part, on a sequence of measurements indicative of one or more positions of the device applied to samples of a probability distribution approximated at least in part using past measurements of positions of devices in the indoor environment.

In accordance with one other aspect, an article of manufacture may be provided which comprises a non-transitory computer readable medium having stored therein computer implementable instructions that are executable by one or more processing units in a computing platform to: determine one or more feasible paths in a routability graph corresponding to an electronic map for an indoor environment, the routability graph representing a two-dimensional grid comprising edges connecting nodes at angles selected from a predetermined set of discrete angles relative to a datum; and selectively estimate a trajectory of a mobile device along the one or more feasible paths based, at least in part, on a sequence of measurements indicative of one or more positions of the device applied to samples of a probability distribution approximated at least in part using past measurements of positions of devices in the indoor environment.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example environment that includes a computing device and a mobile device, one or more of which may provide or otherwise support mobile device positioning based, at least in part, on a routability graph comprising a predetermined number of weighted edges for estimating a trajectory of the mobile device, in accordance with an example implementation.

FIG. 2 is a schematic block diagram illustrating certain features of an example computing platform in a computing device to provide or otherwise support mobile device positioning based, at least in part, on a routability graph comprising a predetermined number of weighted edges, in accordance with an example implementation.

FIG. 3 is a schematic block diagram illustrating certain features of an example computing platform in a mobile device to provide or otherwise support mobile device positioning based, at least in part, on a routability graph comprising a predetermined number of weighted edges, in accordance with an example implementation.

FIG. 4 is a diagram showing certain example features of an indoor environment that may be represented in an electronic map, in accordance with an example implementation.

FIG. 5 is a diagram showing a multi-dimensional grid pattern, in accordance with an example implementation.

FIG. 6 is a diagram showing a multi-dimensional grid pattern, as in FIG. 5 in an overlay on a representative indoor environment, as in FIG. 4, in accordance with an example implementation.

FIG. 7 is a diagram based on the overlay in FIG. 6, illustrating an example routability graph having a plurality of nodes interconnected by edges which may correspond to feasible paths within the example indoor environment of FIG. 4, in accordance with an example implementation.

FIG. 8 is a diagram showing another multi-dimensional grid pattern, in accordance with certain other example implementations.

FIGS. 9A and 9B are diagrams showing certain other multi-dimensional piecewise-regular grid patterns, in accordance with certain other example implementations.

FIG. 10 is a diagram illustrating an example portion of routability graph having a plurality of nodes interconnected by a predetermined number of edges, in accordance with an example implementation.

FIG. 11 is a diagram based on the routability graph in FIG. 7, illustrating a simulated trajectory and a possible estimated trajectory of a mobile device with respect to the routability graph in the example indoor environment, in accordance with an example implementation.

FIG. 12 is a flow diagram illustrating an example process that may be implemented in whole or in part in a computing platform of a computing device and/or a mobile device to provide or otherwise support mobile device positioning based, at least in part, on a routability graph comprising a predetermined number of weighted edges, in accordance with an example implementation.

FIG. 13 is a flow diagram illustrating an example process that may be implemented in whole or in part in a computing platform of a mobile device to provide or otherwise support mobile device positioning based, at least in part, on a routability graph comprising a predetermined number of weighted edges, in accordance with an example implementation.

FIG. 14 is a flow diagram illustrating an example process that may be implemented in whole or in part in a computing platform of a computing device and/or a mobile device to provide or otherwise support mobile device positioning based, at least in part, on a routability graph comprising a predetermined number of weighted edges, in accordance with an example implementation.

### DETAILED DESCRIPTION

As illustrated by the examples herein, various methods, apparatuses and articles of manufacture may be implemented for use in one or more computing platforms to provide or otherwise support mobile device positioning based, at least in part, on a routability graph comprising a predetermined number of weighted edges for estimating a trajectory of a mobile device.

Particle filter models have been used to model movement of objects in two or three dimensions, for example. Here, over a time period a “particle” may transition from an initial position and/or state to a subsequent position and/or state in any one of an indefinite number of directions from the initial position. Possible transitions to particular subsequent positions and/or states may be modeled according to a probability model conditioned on the initial position and/or state. In a particular example, the likelihood that a particle would have a particular subsequent location, velocity and heading may be conditioned on an initial location, velocity and heading for the particle.

Unfortunately, use of classic particle filter models may be impractical in navigation applications hosted on a mobile device that has limited battery life and/or processing capabilities. Specifically, computing the likelihoods of possible transitions in an indefinite number of directions from an initial position may be too computationally burdensome to implement on a mobile device.

In accordance with certain example implementations, a grid of points (nodes) may be arranged over an area covered by an electronic map representative of an indoor area such as a floor of an office building, shopping mall, school building, etc. Neighboring points (nodes) may then be selectively connected by edges subject to features in the map to indicate possible direct transitions between locations of the neighboring points without obstruction (e.g., walls). Here, particular “feasible” paths may be determined from available “candidate” paths connecting grid points. As such, the applied edges connect grid points as “nodes” in a routability graph for use in modeling movement of a mobile device in the indoor area. If the grid of points is a two-dimensional rectangular (or square) grid with uniform spacing for each respective dimension, for example, there may be at most eight distinct transitions from any one node to a neighboring node.

As described in greater detail in subsequent sections, if grid points are provided in a square grid, edges connecting neighboring grid points may be positioned at angles selected from a predetermined set of provided at 45 degree increments. Similarly, if grid points are provided in a square grid, the length of edges connecting adjacent or neighboring nodes may be selected as being one of two different lengths.

In particular example implementations, a location of a mobile device may be modeled as being placed at points along edges connecting neighboring nodes in a routability graph, e.g. as described herein. Likewise, transitions from an initial position to a subsequent position may be modeled to occur along edges of such a routability graph. In addition, a likelihood model may further characterize possible transitions of a mobile device from an initial position to a subsequent over a time period.

As in the example particle filtering model discussed above, the likelihood that a mobile device may have a particular subsequent location, velocity and heading may be conditioned on an initial location, velocity and heading, and/or the like or some combination thereof. However, since possible transitions are limited to movement along edges connecting neighboring nodes in the routability graph (rather than transitioning any one of an indefinite number of directions), such a model may be applied in navigation applications performed by mobile devices with limited battery life and/or processing power.

In certain example implementations, a likelihood model as described herein may be prepared in advance, and stored, updated and maintained at a location server. Mobile devices entering an indoor area of interest may, for example, obtain such a likelihood model, a routability graph, and/or other like data files over one or more wireless communication links. In certain instances, a likelihood model, routability graph, and/or the like may be developed over time using a history of location measurements and/or position fixes in the area, in addition to heuristic modeling of mobile devices along edges of the routability graph.

In certain example implementations, a probability distribution/model characterizing a state or movement of a mobile device along edges of a routability graph may be approximated based, at least in part, on direct and/or indirect measurements over time. Here, for example, an approximation probability distribution/model may be updated and/or propagated over time from direct and/or indirect measurements. In certain instances, an approximated probability distribution may, for example, be sampled for obtaining an estimate of the state of the mobile device. Particles may, for example, be used to represent a quantum of probability on an estimation state-space.

In certain example implementations, one or more direct measurements, e.g., used for updating/propagating the approximated probability distribution/model, may comprise signal strength measurements (e.g., RSSI, etc.) from one or more access points, SPS signal and/or corresponding position measurements, a round-trip delay, etc. In certain example implementations, one or more indirect measurements, e.g., used for updating/propagating the approximated probability distribution, may include measurements from on-board accelerometers, etc.

In accordance with certain aspects, recognizing that transitions of a mobile device may be constrained to locations along the aforementioned routability graph, such transitions in a mobile device's trajectory may be modeled according to a Markov process, and/or the like. For example, such a Markov process may be based, at least in part, on a table of a priori transition probabilities between possible states as constrained according to the routability graph. Here, for example, such a Markov process and/or the like may model, for example, a state of the mobile device including location, velocity and/or heading. Additionally, placement of edges connecting neighboring grid points at a limited number of angles, e.g., in discrete 45 degree increments, and/or at limited number of lengths, may greatly simplify and/or the West reduce data storage for implementation of a particle filter model on a mobile device.

In accordance with certain example implementations, a computing platform may be provided to obtain a routability graph corresponding to an electronic map of at least a portion of an indoor environment. Here, for example, a routability graph may specify a predetermined number of feasible paths for an object (e.g., a person carrying a mobile device) to follow within the portion of the indoor environment. Further, for example at least one of the predetermined number of feasible paths may be defined as passing through at least one of a plurality of nodes arranged at intersecting points of a multi-dimensional grid. Thus, for example, each of the plurality of nodes may be interconnected to one or more neighboring nodes via at least one, but no more than a threshold number of edges. A computing platform may, for example, determine a weight value for a particular edge connected to at least one node based, at least in part, on a likelihood that an estimated trajectory of the object having reached the node subsequently follows the particular edge away from the node.

In certain implementations, a computing platform may, for example, identify an edge length value of an edge, wherein such an edge length value may be one of a predetermined number of edge length values. Here, for example, each of the predetermined number of edge length values may represent a corresponding distance within the indoor environment.

In certain implementations, a computing platform may, for example, further determine a second weight value for a particular edge based, at least in part, on one or more features of the electronic map, e.g. within some threshold distance of the particular edge. In certain instances, for example, the computing platform may determine a second weight value for a particular edge based, at least in part, on one or more other weight values for one or more neighboring nodes interconnected to a node that the mobile device is currently positioned at or nearby.

In accordance with certain example implementations, intersecting points of a multi-dimensional grid may be uniformly distributed with regard to at least one dimension. In certain instances, as previously mentioned, a multi-dimensional grid may comprise a two-dimensional square grid, for example. In accordance with certain example implementations, as previously mentioned, the threshold number of edges may be based on a maximum number of neighboring nodes.

In accordance with certain example implementations, a computing platform may, for example, be provided to preprocess at least one weight value, and/or other applicable information associated with a routability graph. Thus, for example, in certain instances, a computing platform may initiate transmission (e.g., over one or more wireless and/or wired communication links) of at least a weight value for at least one edge to at least one mobile device. In accordance with certain other example implementations, a computing platform may be provided in a mobile device.

In accordance with certain other aspects, a mobile device may obtain a routability graph and at least one weight value for at least one edge therein, and may affect a decision of a motion model to transition a state along the edge in estimating a trajectory of the mobile device based, at least in part, on the weight value. In certain instances, the mobile device may further obtain one or more measurement values indicative of movement of the mobile device within the indoor environment, and affect the motion model in estimating the trajectory of the mobile device based, at least in part, on the one or more measurement values. By way of example, device may obtain one or more measurement values via one or more sensors, such as, e.g., one or more communication interfaces, one or more inertial sensors, one or more environmental sensors, and/or the like or some combination thereof.

In accordance with certain example implementations, a mobile device may obtain measurement information indicative of one or more positions of the mobile device applied to samples of a probability distribution approximated, at least in part, using past measurements of positions of the mobile device and/or other mobile devices within the indoor environment. Such a mobile device may, for example, further affect a motion model in estimating the trajectory of the mobile device based, at least in part, on the measurement information.

In accordance with certain example implementations, a mobile device may further identify an edge length value for a particular edge, wherein the edge length value may represent a corresponding distance traveled in the indoor environment with respect to the electronic map. Such a mobile device may, for example, further affect a motion model in estimating the trajectory of the mobile device based, at least in part, on the edge length value.

In accordance with certain example implementations, a mobile device may further obtain a second weight value for a particular edge, wherein the second weight value may be based, at least in part, on one or more features of the electronic map, e.g., within a threshold distance of the particular edge. Such a mobile device may, for example, further affect a decision of a motion model to transition a state along the particular edge in estimating a trajectory of the mobile device based, at least in part, on the second weight value. In certain instances, a second weight value for a particular edge may, for example, be based, at least in part, on one or more other weight values for one or more neighboring nodes interconnected to the node of the mobile device is currently be at or near.

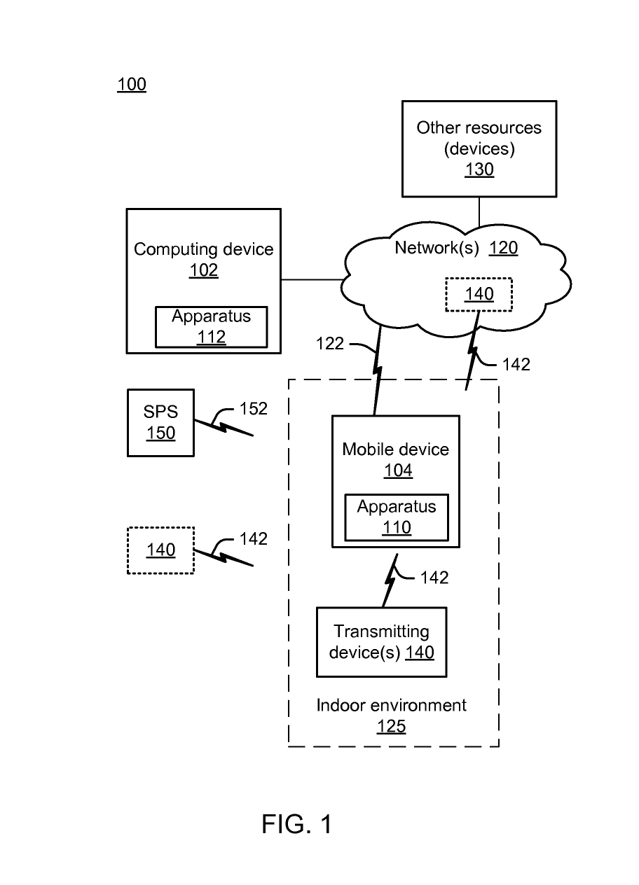

Attention is drawn next to FIG. 1, which is a schematic block diagram illustrating an example environment 100 that includes a computing device 102 and a mobile device 104, one or more of which may provide or otherwise support mobile device positioning based, at least in part, on a routability graph comprising a predetermined number of weighted edges for estimating a trajectory of the mobile device, in accordance with an example implementation.

As shown, computing device 102 comprises an apparatus 112 to provide or otherwise support mobile device positioning based, at least in part, on a routability graph comprising a predetermined number of weighted edges for estimating a trajectory of mobile device 104 within an indoor environment 125. Apparatus 112 may represent one or more computing platforms that may communicate with one or more other resources (devices) 130, either directly and/or indirectly, e.g. via one or more network(s) 120. Apparatus 112 may communicate with mobile device 104, either directly and/or indirectly, the latter which is illustrated using network(s) 120 and wireless communication link 122. While computing device 102 happens to be illustrated in this example as being located outside of indoor environment 125, it should be recognized that in certain other implementations, all or part of computing device 102 and/or apparatus 112 may be located within indoor environment 125.

Network(s) 120 may comprise one or more communication systems and/or data networks having various interconnected devices supporting communication between computing device 102 and one or more other resources (devices) 130. As mentioned, network(s) 120 may further support communication between computing device 102 and mobile device 104. For example, communication between computing device 102 and mobile device 104 may allow for certain data and/or instructions to be exchanged there between.

As used herein a “mobile device” may represent any electronic device that may be moved about either directly or indirectly by a user within an indoor environment and which may communicate with one or more other devices via one or more wired and/or wireless communication links. Some examples include a cell phone, a smart phone, a computer (e.g., a personal computer such as a laptop computer, tablet computer, a wearable computer, etc.), a navigation aid, a tracking device, a digital book reader, a gaming device, music and/or video player device, a camera, a machine, a robot, etc.

Other resources (devices) 130 may represent one or more computing platforms from which computing device 102 and/or mobile device 104 may obtain certain data files and/or instructions, and/or to which computing device 102 and/or mobile device 104 may provide certain data files and/or instructions. For example, in certain instances, all or part of an electronic map and/or the like may be obtained by computing device 102 and/or mobile device 104 from one or more other resources (devices) 130. For example, in certain instances, all or part of a set of instructions for use in apparatus 112 and/or apparatus 110 may be obtained from other resources (devices) 130.

Example environment 100 further includes a satellite positioning system (SPS) 150 which may transmit one or more SPS signals 152 to mobile device 104. SPS 150 may, for example, represent one or more GNSS, one or more regional navigation satellite systems, and/or the like or some combination thereof. Additionally, one or more terrestrial-based positioning systems may be provided as represented by example transmitting device(s) 140 capable of transmitting one or more wireless signals 142 all or some of which may be used for signal-based positioning. Thus for example, transmitting device(s) 140 may represent a wireless access point, a base station, a repeater, a dedicated beacon transmitting device, just to name a few examples, which have known positions. SPS signals 152 and/or wireless signals 142 may, at times, be acquired by mobile device 104 and used to estimate its position.

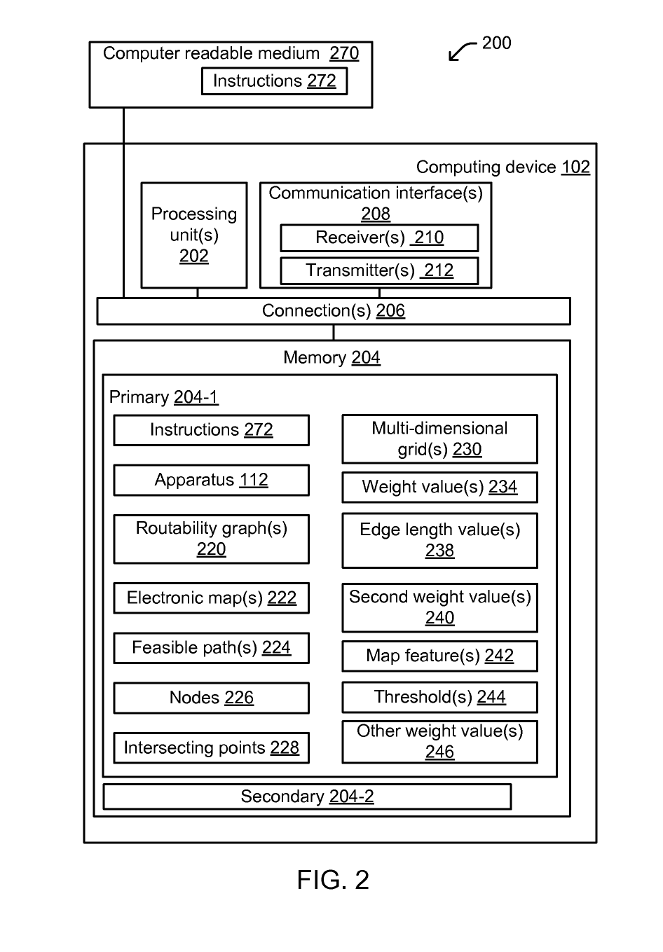

Attention is drawn next to FIG. 2, which is a schematic block diagram illustrating certain features of an example computing platform 200 in a computing device 102 to provide or otherwise support mobile device positioning based, at least in part, on a routability graph comprising a predetermined number of weighted edges, in accordance with an example implementation.

As illustrated computing platform 200 may comprise one or more processing units 202 to perform data processing (e.g., in accordance with the techniques provided herein, as part of apparatus 112, etc.) coupled to memory 204 via one or more connections 206. Processing unit(s) 202 may, for example, be implemented in hardware or a combination of hardware and software. Processing unit(s) 202 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co-located/coupled with processing unit(s) 202, or other like circuitry within computing platform 200. Secondary memory 204-2 may comprise, for example, the same or similar type of memory as primary memory and/or one or more data storage devices or systems, such as, for example, a disk drive, an optical disc drive, a tape drive, a solid state memory drive, etc.

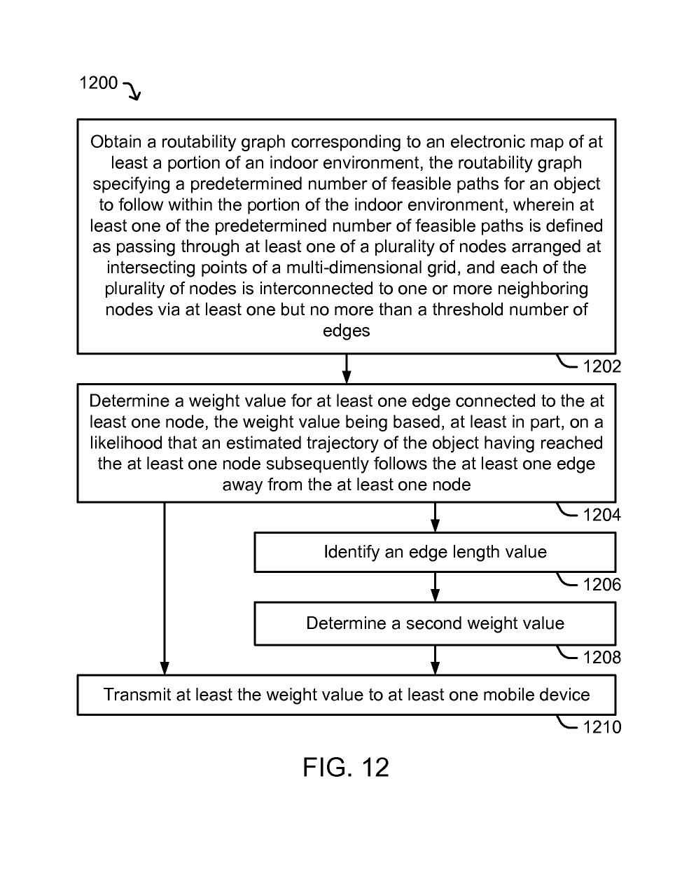

In certain implementations, secondary memory may be operatively receptive of, or otherwise configurable to couple to, a non-transitory computer readable medium 270. Memory 204 and/or non-transitory computer readable medium 270 may comprise instructions 272 associated with data processing, e.g., in accordance with the techniques and/or example apparatus 112 (FIG. 1) and/or all or part of example process 1200 (FIG. 12), as provided herein.

Computing platform 200 may, for example, further comprise one or more communication interface(s) 208. Communication interface(s) 208 may, for example, provide connectivity to network(s) 120, mobile device 104, and/or other resources (devices) 130 (FIG. 1), e.g., via one or more wired and/or wireless communication links. As illustrated here communication interface(s) 208 may comprise one or more receiver(s) 210, one or more transmitter(s) 212, and/or the like or some combination thereof. Communication interface(s) 208 may implement one or more communication protocols as may be required to support one or more wired and/or wireless communication links.

Processing unit(s) 202 and/or instructions 282 may, for example, provide or otherwise be associated with one or more signals that may be stored in memory 204 from time to time, such as: instructions 272; apparatus 112; one or more routability graphs 220; one or more electronic maps 222; one or more feasible paths 224; one or more nodes 226; one or more intersecting points 228; one or more multi-dimensional grids 230; one or more weight values 234; one or more edge length values 238; one or more second weight values 240; one or more map features 242; one or more thresholds 244; one or more other weight values 246; and/or the like or some combination thereof.

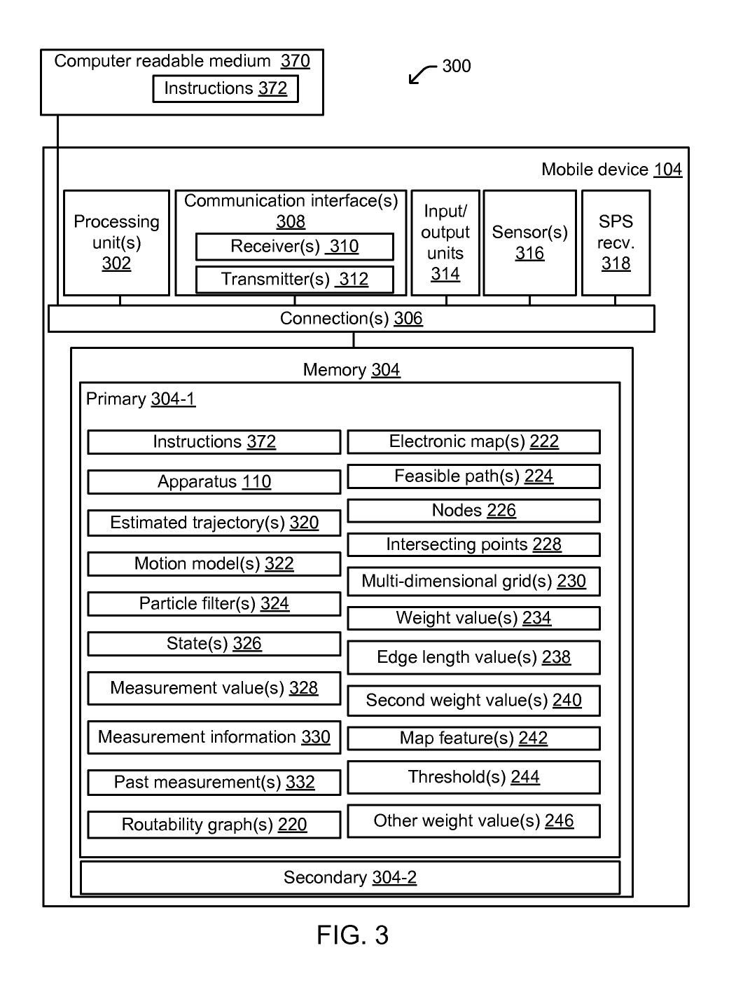

Attention is drawn next to FIG. 3, which is a schematic block diagram illustrating certain features of an example computing platform 300 in a mobile device 104 to provide or otherwise support mobile device positioning based, at least in part, on a routability graph comprising a predetermined number of weighted edges, in accordance with an example implementation.

As illustrated computing platform 300 may comprise one or more processing units 302 to perform data processing (e.g., in accordance with the techniques provided herein, and/or apparatus 110, etc.) coupled to memory 304 via one or more connections 306. Processing unit(s) 302 may, for example, be implemented in hardware or a combination of hardware and software. Processing unit(s) 302 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 304 may be representative of any data storage mechanism. Memory 304 may include, for example, a primary memory 304-1 and/or a secondary memory 304-2. Primary memory 304-1 may comprise, for example, a random access memory, read only memory, etc. While illustrated in this example as being separate from the processing units, it should be understood that all or part of a primary memory may be provided within or otherwise co-located/coupled with processing unit(s) 302, or other like circuitry within mobile device 104. Secondary memory 304-2 may comprise, for example, the same or similar type of memory as primary memory and/or one or more data storage devices or systems, such as, for example, a disk drive, an optical disc drive, a tape drive, a solid state memory drive, etc

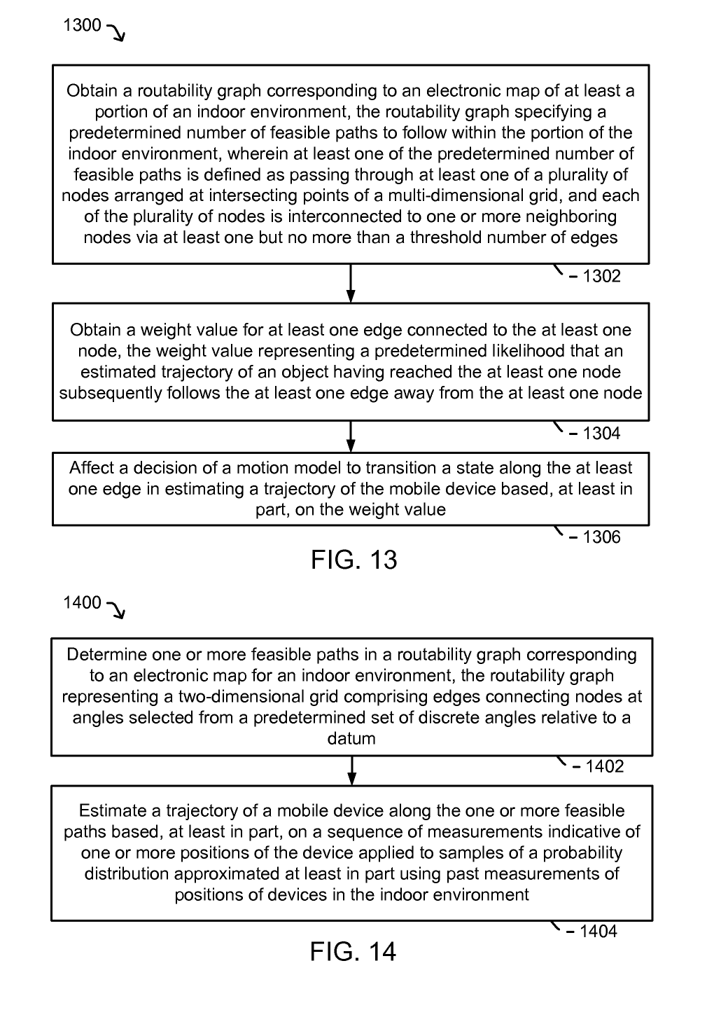

In certain implementations, secondary memory may be operatively receptive of, or otherwise configurable to couple to, a non-transitory computer readable medium 370. Memory 304 and/or non-transitory computer readable medium 370 may comprise instructions 372 associated with data processing, e.g., in accordance with the techniques and/or example apparatus 110 (FIG. 1) and/or all or part of one or more example processes 1200 (FIG. 12), 1300 (FIG. 13), 1400 (FIG. 14), as provided herein.

Computing platform 300 may, for example, further comprise one or more communication interface(s) 308. Communication interface(s) 308 may, for example, provide connectivity to network(s) 120, computing device 102, and/or other resources (devices) 130 (FIG. 1), e.g., via one or more wired and/or wireless communication links. As illustrated here communication interface(s) 308 may comprise one or more receivers 310, one or more transmitters 312, and/or the like or some combination thereof. Communication interface(s) 308 may implement one or more communication protocols as may be required to support one or more wired and/or wireless communication links. Communication interface(s) 308 may, in certain example instances, further comprise one or more receivers capable of receiving wireless signals 142 from one or more transmitting devices 140 associated with one or more terrestrial-based positioning systems. Further, in certain example instances, mobile device 104 may comprise an SPS receiver 318 capable of receiving and processing SPS signals 152 in support of one or more signal-based positioning capabilities.

In accordance with certain example implementations, communication interface(s) 208, communication interface(s) 308, and/or other resources in network(s) 120 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 208 and/or communication interface(s) 308 may further provide for infrared-based communications with one or more other devices.

Mobile device 104 may, for example, further comprise one or more input/output units 314. Input/output units 314 may represent one or more devices or other like mechanisms that may be used to obtain inputs from and/or provide outputs to one or more other devices and/or a user of mobile device 104. Thus, for example, input/output units 314 may comprise various buttons, switches, a touch pad, a trackball, a joystick, a touch screen, a microphone, a camera, and/or the like, which may be used to receive one or more user inputs. In certain instances, input/output units 314 may comprise various devices that may be used in producing a visual output, an audible output, and/or a tactile output for a user. For example, input/output units 314 may comprise a display screen, a speaker, a vibrating device, etc.

Mobile device 104 may, for example, comprise one or more sensors 316. For example, sensor(s) 316 may represent one or more inertial sensors, one or more environmental sensors, etc., which may be useful in detecting aspects of the environment 100 and/or mobile device 104. Thus for example, sensor(s) 316 may comprise one or more accelerometers, one or one or more gyroscopes or gyrometers, one or more magnetometers and/or the like, one or more barometers, one or more thermometers, etc. Further, in certain instances sensor(s) 316 may comprise one or more input devices such as a microphone, a camera, a light sensor, etc.

Processing unit(s) 302 and/or instructions 372 may, for example, provide or otherwise be associated with one or more signals that may be stored in memory 304 from time to time and which may represent data and/or instructions, such as: instructions 372; apparatus 110; one or more estimated trajectories 320; one or more motion models 322; one or more particle filters 324; one or more states 326; one or more measurement values 328; various measurement information 330; one or more past measurements 332; one or more routability graphs 220; one or more electronic maps 222; one or more feasible paths 224; one or more nodes 226; one or more intersecting points 228; one or more multi-dimensional grids 230; one or more weight values 234; one or more edge length values 238; one or more second weight values 240; one or more map features 242; one or more thresholds 244; one or more other weight values 246; and/or the like or some combination thereof. While some of the example data and/or instructions as illustrated in FIG. 3 share the same reference numbers as example data and/or instructions as illustrated in FIG. 2, it should be kept in mind that in certain instances all or part of such example data and/or instructions may be distinctly different.

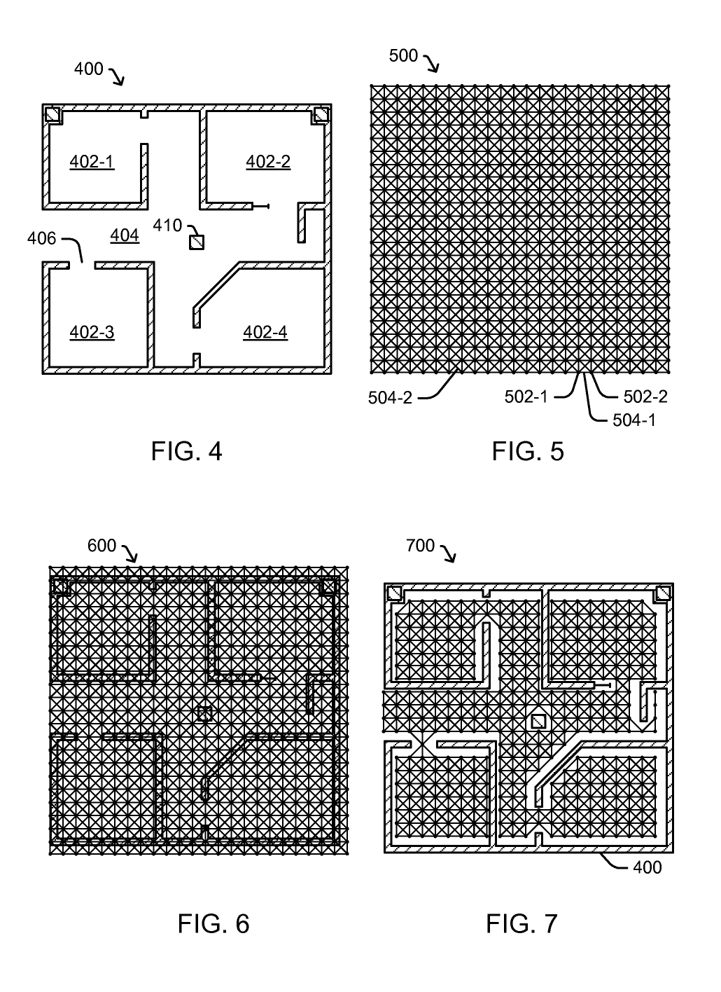

Attention is drawn next to FIG. 4, which is a diagram 400 showing certain example features of an indoor environment that may be represented in an electronic map, in accordance with an example implementation. By way of example, diagram 400 may represent a visual presentation of all or some of the information that may be provided in one or more data files and/or instructions associated with an electronic map for indoor environment.

As illustrated, example diagram 400 presents several features that may constrain the movement of a person carrying a mobile device in some manner while navigating within an indoor environment. Diagram 400 depicts four rooms, 402-1, 402-2, 402-3, and 402-4, which have openings to a common hallway 404. Here for example, room 402-3 is connected to hallway 404 via doorway or other like opening 406. As further illustrated in addition to the walls or other like partitions illustrated in diagram 400, a structural member 410 is also depicted near the center of diagram 400. Hence, as would be expected, a person carrying a mobile device may be able to navigate through part of hallway 404 and possibly enter one or more of the rooms shown via their doorway and/or other like openings. Further, as would be expected, he person carrying a mobile device may be unable to navigate through one of the walls and/or other like partitions, and/or structural member 410. It should be kept in mind that diagram 400 is intended just to provide a simple example.

Additionally, in certain implementations, an electronic map and/or other like related data may be further defined one or more features or other objects that may also be taken into consideration in determining feasible paths within an indoor environment. For example, in certain implementations of electronic map may further specify desks, tables, display cases, staircases, elevators, escalators, plumbing fixtures, machines, etc.

Reference is made next to FIG. 5, which is a diagram showing a multi-dimensional grid pattern 500, in accordance with an example implementation. Example multi-dimensional grid pattern 500 comprises a two-dimensional square grid pattern comprising a plurality of grid points or nodes such as nodes 502-1 and 502-2, which are neighboring nodes to one another and as illustrated connected by an edge 504-1. As will be appreciated, in this example, horizontal and vertical aligned edges will share a common edge length (and edge length value), and similarly, and diagonal aligned edges, e.g., such as edge 504-2, will also share another common edge length (and edge length value) which will be longer than the common edge length of the horizontal and vertical aligned edges.

Attention is drawn next to FIG. 6, which is a diagram 600 showing multi-dimensional grid pattern 500 in an overlay of diagram 400, in accordance with an example implementation. As can be seen, various features in diagram 400, such as the illustrated walls and/or other partitions, will interfere with some of the nodes and interconnecting edges of grid pattern 500.

Accordingly, as illustrated in FIG. 7, an example routability graph 700 may be specified within diagram 400 as having a plurality of nodes interconnected by edges which may correspond to feasible paths within the example indoor environment.

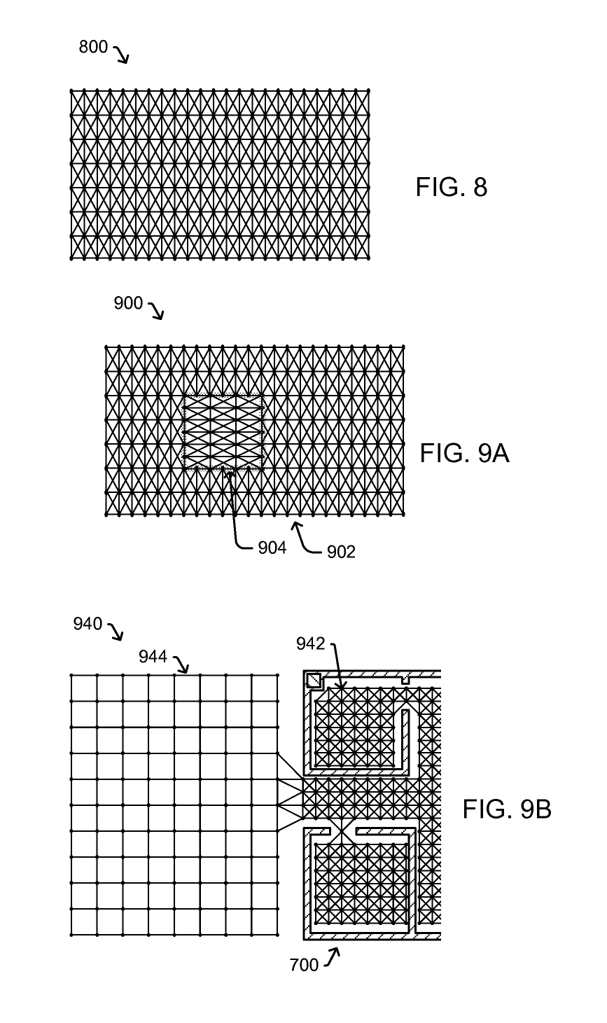

As mentioned, in certain example implementations a multi-dimensional grid pattern need not necessarily be square or otherwise uniform with regard to the pattern/dimensions. Thus, for example, as illustrated in FIG. 8, grid pattern 800 comprises a rectangular pattern.

In other examples, as illustrated in FIGS. 9A and 9B certain example grid patterns may comprise two or more different patterns, e.g., to form a piecewise-regular grid patterns 900 and 940, respectively. As illustrated, for example, grid pattern 900 comprises portions 902 and 904 which have different patterns. As illustrated, for example, grid pattern 940 comprises portions 942 and 944 which have different patterns. In this example, the grid pattern in portion 944 presents a coarser grid then does the grid pattern in portion 942. As may be appreciated, a grid pattern or portion thereof may be particularly selected based on all or part of an indoor and/or outdoor environment, and/or other like factors. In accordance with certain other example implementations, other grid patterns using one or different polygons or other possibly beneficial patterns/shapes, uniform or non-uniform, may be implemented.

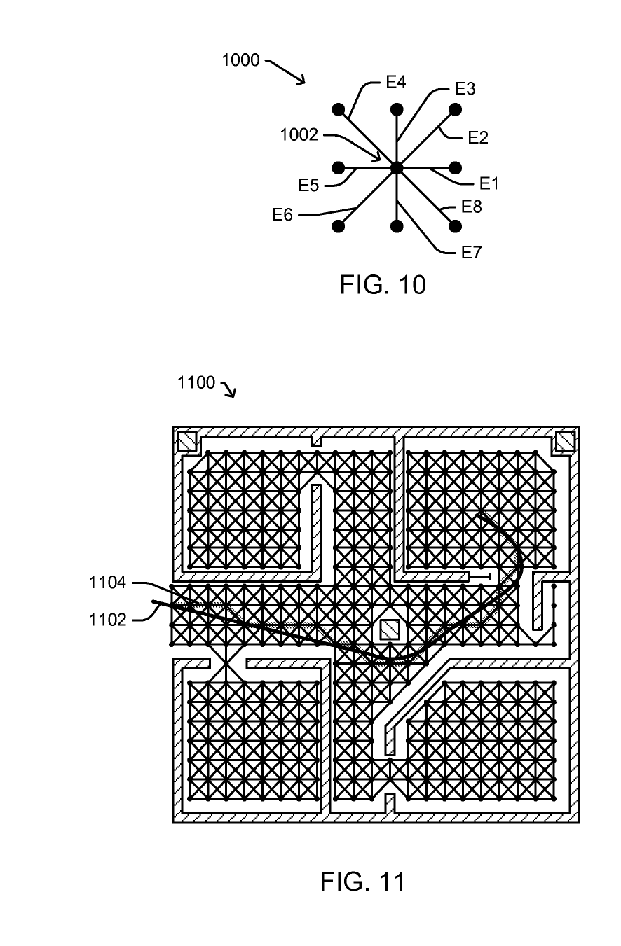

Attention is drawn next to FIG. 10, which is a diagram 1000 illustrating an example portion of routability graph having a plurality of nodes (represented by dark circles) interconnected by a predetermined number of edges (represented by lines), in accordance with an example implementation. In diagram 1000, at the center, is an example node 1002 which is connected to its eight neighboring nodes by edges E1 through E8. As can be seen by this example implementation, there are a predetermined number of edges (here, eight) which are separated by 45° increments from the center of node 1002. As can be seen, in this example, edges E1 and E5 run horizontally and have the same (shorter) length as edges E3 and E7 which run vertically as shown in FIG. 10. Similarly, in this example, the diagonal edges E2, E4, E6, and E8 have the same (longer) length. As may be appreciated, in certain instances, a weight may be assigned to each of the edges which may indicate likelihood that an estimated trajectory of the object having reached node 1002 subsequently follows a particular edge to one of its neighboring nodes.

Reference is made next to FIG. 11, which is an example diagram 1100 based on routability graph 700, illustrating a simulated trajectory 1102 and a possible estimated trajectory 1104 of a mobile device with respect to certain nodes and interconnecting edges of routability graph 700.

Reference is made next to FIG. 12, which is a flow diagram illustrating an example process 1200 that may be implemented in whole or in part in a computing platform of a computing device and/or a mobile device to provide or otherwise support mobile device positioning based, at least in part, on a routability graph comprising a predetermined number of weighted edges, in accordance with an example implementation.

At example block 1202, a routability graph corresponding to an electronic map of at least a portion of an indoor environment may be obtained. Here, for example, the routability graph may specify a predetermined number of feasible paths for an object to follow within the portion of said indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges.

In example block 1204, a weight value for at least one edge connected to said at least one node may be determined. Here, for example, a weight value may be based, at least in part, on a likelihood that an estimated trajectory of an object having reached at least one node subsequently follows the at least one edge away from the at least one node

In certain example implementations, at block 1206, an edge length value may be determined. In certain example implementations, at block 1208, a second weight value for an adage may be determined. In certain example implementations, at block 1210, at least one weight value may be transmitted to at least one mobile device.

Attention is drawn next to FIG. 13, which is a flow diagram illustrating an example process 1300 that may be implemented in whole or in part in a computing platform of a mobile device to provide or otherwise support mobile device positioning based, at least in part, on a routability graph comprising a predetermined number of weighted edges, in accordance with an example implementation.

At example block 1302, a routability graph corresponding to an electronic map of at least a portion of an indoor environment may be obtained. Here, for example, the routability graph may specify a predetermined number of feasible paths to follow within said portion of the indoor environment, wherein at least one of the predetermined number of feasible paths is defined as passing through at least one of a plurality of nodes arranged at intersecting points of a multi-dimensional grid, and each of the plurality of nodes is interconnected to one or more neighboring nodes via at least one but no more than a threshold number of edges.

At example block 1304, a weight value may be obtained for at least one edge connected to the at least one node. Here, for example, the weight value may represent a predetermined likelihood that an estimated trajectory of an object having reached the at least one node subsequently follows the at least one edge away from the at least one node. In certain example implementations, a weight value may be predetermined by one or more computing platforms within mobile device or within an external computing device. In certain other example implementations, a weight value may be dynamically determined.

At example block 1306, a decision of a motion model to transition a state along the at least one edge in estimating a trajectory of the mobile device may be affected based, at least in part, on the weight value. In certain example implementations, block 1306 (and/or other example blocks in the example processes provided herein) may comprise presenting one or more outputs for a user, e.g., via one or more input/output units. Such output(s) may be based, at least in part, on the process performed. Hence, for example, at block 1306, navigation information relating to a motion model, a trajectory, a position, an electronic map, etc., may be provided in some manner to the user.

Attention is drawn next to FIG. 14, which is a flow diagram illustrating an example process 1400 that may be implemented in whole or in part in a computing platform of a computing device and/or a mobile device to provide or otherwise support mobile device positioning based, at least in part, on a routability graph comprising a predetermined number of weighted edges, in accordance with an example implementation.

At example block 1402, one or more feasible paths in a routability graph corresponding to an electronic map for an indoor environment may be determined. Here, for example, the routability graph may represent a two-dimensional grid comprising edges connecting nodes at angles selected from a predetermined set of discrete angles relative to a datum.

At example block 1404, a trajectory of a mobile device along the one or more feasible paths may be selectively estimated based, at least in part, on a sequence of measurements indicative of one or more positions of the device applied to samples of a probability distribution approximated at least in part using past measurements of positions of devices in the indoor environment. By way of example, in certain implementations, edge length values of the edges may be from a predetermined set of lengths, the discrete angles may be provided in 45 degree increments, and/or the nodes connected by the edges may be arranged at intersecting points in a square grid, the discrete angles may comprise integer multiples of a discrete sub-angle (e.g., 45°).

In accordance with certain aspects, a computing platform may provide a combination of real-time positioning and/or post-positioning capabilities. In certain implementations, such capabilities may be distributed amongst a plurality of devices, and/or performed within a single device having one or more computing platforms. In accordance with certain example implementations, the techniques provided herein that estimate trajectories and/or positions of mobile devices within an indoor environment based on sensor measurements and electronic map information may be implemented without the use and/or consideration of any signal-based positioning signals.

With regard to first and second weights that may be associated an edge of a routability graph and/or the like, in certain example implementations a two-layer or other like weight factoring process may be implemented to determine and/or otherwise affect a likelihood for a movement from one node to a neighboring node along a given edge. Here, for example, a first factor may be based, at least in part on a model of movement, and may be independent of position on a grid (e.g., not associated with the grid-nodes at all), but instead may describe the probability of changing directions, anywhere on the grid. For example, on a regular grid as in FIG. 8, one may use only five values for the entire grid to represent this probability: one value (probably largest) describing no change in direction (e.g., in FIG. 10, continuing on edge E3 after arriving along the edge E7, or any other such straight pairs); another value (possibly a bit smaller) for changing direction by 45 degrees (e.g., continuing on edge E2 or bench E4 after arriving along the edge E7); another value (possibly smaller yet) for changing direction by 90 degrees (e.g., continuing on edge E1 or edge E5 after arriving along the edge E7); and so on for the 135 degree and 180 degree turns. Again, such an example set of weights may not depend on the specific node on the grid, and/or the direction of approach. Indeed, a possible advantage of a regularity of at least a portion of a grid may be that with only a small number of values describing the turn likelihoods, one may model the motion anywhere on the grid, and in any direction. A second factor may consider a second weight that may be specific to each node of the grid, e.g., placing more weight for example on different regions of a grid based on some utility, an importance, etc., of a given region. Here for example, a second weight may be higher for edges of a corridor or hallway, when compared to edges in a closet, corners of a room, etc.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “applying,” “generating,” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, with a mobile device:
receiving a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node;
affecting a decision of a motion model to transition a state along said at least one edge in estimating a trajectory of said mobile device based, at least in part, on said weight value; and
presenting navigation information that is generated based, at least in part, on said trajectory.

2. The method as recited in claim 1, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges.

3. An apparatus for use in a mobile device, the apparatus comprising:
means for receiving a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node;
means for affecting a decision of a motion model to transition a state along said at least one edge in estimating a trajectory of said mobile device based, at least in part, on said weight value;
means for generating navigation information based, at least in part, on said trajectory; and
means for presenting said navigation information to a user.

4. A mobile device comprising:
a communication interface;
an output unit;
one or more processing units to:
receive, via said communication interface, a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node;
affect a decision of a motion model to transition a state along said at least one edge in estimating a trajectory of said mobile device based, at least in part, on said weight value;
determine navigation information based, at least in part, on said trajectory; and
initiate presentation of said navigation information to a user via said output unit.

5. An article for use by a mobile device, the article comprising:
a non-transitory computer readable medium having stored therein computer implementable instructions executable by one or more processing units in said mobile device to:
receive a weight value for at least one edge connected to at least one node of a routability graph corresponding to an electronic map of at least a portion of an indoor environment, said weight value representing a predetermined likelihood that an estimated trajectory of an object having reached said at least one node subsequently follows said at least one edge away from said at least one node;
affect a decision of a motion model to transition a state along said at least one edge in estimating a trajectory of said mobile device based, at least in part, on said weight value;
determine navigation information based, at least in part, on said trajectory; and
initiate presentation of said navigation information to a user via an output unit.

6. A method comprising, with a mobile device:
obtaining a routability graph corresponding to an electronic map of at least a portion of an indoor environment, said routability graph specifying a predetermined number of feasible paths to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges;
obtaining a weight value for at least one edge connected to said at least one node, said weight value representing a predetermined likelihood that an estimated trajectory of an object having reached said at least one node subsequently follows said at least one edge away from said at least one node; and
affecting a decision of a motion model to transition a state along said at least one edge in estimating a trajectory of said mobile device based, at least in part, on said weight value.

7. The method as recited in claim 6, and further comprising, with said mobile device:
obtaining one or more measurement values indicative of movement of said mobile device within said indoor environment; and
affecting said motion model in estimating said trajectory of said mobile device based, at least in part, on said one or more measurement values.

8. The method as recited in claim 7, and further comprising, with said mobile device:
obtaining said one or more measurement values via one or more sensors, said one or more sensors comprising at least one of: one or more communication interfaces; one or more inertial sensors; and/or one or more environmental sensors.

9. The method as recited in claim 6, and further comprising, with said mobile device:
obtaining measurement information indicative of one or more positions of said mobile device applied to samples of a probability distribution approximated, at least in part, using past measurements of positions of said mobile device and/or other mobile devices within said indoor environment; and
affecting said motion model in estimating said trajectory of said mobile device based, at least in part, on said measurement information.

10. The method as recited in claim 6, and further comprising, with said mobile device:
identifying an edge length value for at least said at least one edge, said edge length value representing a corresponding distance traveled in said indoor environment with respect to said electronic map; and
affecting said motion model in estimating said trajectory of said mobile device based, at least in part, on said edge length value.

11. The method as recited in claim 6, and further comprising, with said mobile device:
obtaining a second weight value for said at least one edge, said second weight value being based, at least in part, on one or more features of said electronic map within a threshold distance of said at least one edge; and
affecting said decision of said motion model to transition said state along said at least one edge in estimating said trajectory of said mobile device based, at least in part, on said second weight value.

12. The method as recited in claim 11, wherein said second weight value for said at least one edge based, at least in part, on one or more other weight values for at least one of said one or more neighboring nodes interconnected to said at least one node.

13. The method as recited in claim 6, wherein said intersecting points of said multi-dimensional grid are uniformly distributed with regard to at least one dimension.

14. The method as recited in claim 13, wherein said multi-dimensional grid comprises a two-dimensional square grid.

15. The method as recited in claim 6, wherein said threshold number of edges is based on a maximum number of neighboring nodes.

16. An apparatus for use in a mobile device, the apparatus comprising:
means for obtaining a routability graph corresponding to an electronic map of at least a portion of an indoor environment, said routability graph specifying a predetermined number of feasible paths to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges;
means for a weight value for at least one edge connected to said at least one node, said weight value representing a predetermined likelihood that an estimated trajectory of an object having reached said at least one node subsequently follows said at least one edge away from said at least one node; and
means for affecting a decision of a motion model to transition a state along said at least one edge in estimating a trajectory of said mobile device based, at least in part, on said weight value.

17. The apparatus as recited in claim 16, and further comprising:
means for obtaining one or more measurement values indicative of movement of said mobile device within said indoor environment; and
means for affecting said motion model in estimating said trajectory of said mobile device based, at least in part, on said one or more measurement values.

18. The apparatus as recited in claim 17, and further comprising:
means for obtaining said one or more measurement values based, at least in part, one or more wireless signals, one or more sensed inertial forces, and/or one or more sensed environmental parameters.

19. The apparatus as recited in claim 16, and further comprising:
means for obtaining measurement information indicative of one or more positions of said mobile device applied to samples of a probability distribution approximated, at least in part, using past measurements of positions of said mobile device and/or other mobile devices within said indoor environment; and
means for affecting said motion model in estimating said trajectory of said mobile device based, at least in part, on said measurement information.

20. The apparatus as recited in claim 16, and further comprising:
means for identifying an edge length value for at least said at least one edge, said edge length value representing a corresponding distance traveled in said indoor environment with respect to said electronic map; and
means for affecting said motion model in estimating said trajectory of said mobile device based, at least in part, on said edge length value.

21. The apparatus as recited in claim 16, and further comprising:
means for obtaining a second weight value for said at least one edge, said second weight value being based, at least in part, on one or more features of said electronic map within a threshold distance of said at least one edge; and
means for affecting said decision of said motion model to transition said state along said at least one edge in estimating said trajectory of said mobile device based, at least in part, on said second weight value.

22. The apparatus as recited in claim 21, wherein said second weight value for said at least one edge based, at least in part, on one or more other weight values for at least one of said one or more neighboring nodes interconnected to said at least one node.

23. The apparatus as recited in claim 16, wherein said intersecting points of said multi-dimensional grid are uniformly distributed with regard to at least one dimension.

24. The apparatus as recited in claim 23, wherein said multi-dimensional grid comprises a two-dimensional square grid.

25. The apparatus as recited in claim 16, wherein said threshold number of edges is based on a maximum number of neighboring nodes.

26. A mobile device comprising:
one or more processing units to:
obtain a routability graph corresponding to an electronic map of at least a portion of an indoor environment, said routability graph specifying a predetermined number of feasible paths to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges;
obtain a weight value for at least one edge connected to said at least one node, said weight value representing a predetermined likelihood that an estimated trajectory of an object having reached said at least one node subsequently follows said at least one edge away from said at least one node; and
affect a decision of a motion model to transition a state along said at least one edge in estimating a trajectory of said mobile device based, at least in part, on said weight value.

27. The mobile device as recited in claim 26, said one or more processing units to further:
obtain one or more measurement values indicative of movement of said mobile device within said indoor environment; and
affect said motion model in estimating said trajectory of said mobile device based, at least in part, on said one or more measurement values.

28. The mobile device as recited in claim 27, and further comprising:
at least one of: one or more communication interfaces; one or more inertial sensors; and/or one or more environmental sensors; and
wherein said one or more processing units to further:
obtain said one or more measurement values via at least one of: said one or more communication interfaces; said one or more inertial sensors; and/or said one or more environmental sensors.

29. The mobile device as recited in claim 26, said one or more processing units to further:
obtain measurement information indicative of one or more positions of said mobile device applied to samples of a probability distribution approximated at least in part using past measurements of positions of said mobile device and/or other mobile devices within said indoor environment; and
affect said motion model in estimating said trajectory of said mobile device based, at least in part, on said measurement information.

30. The mobile device as recited in claim 26, said one or more processing units to further:
identify an edge length value for at least said at least one edge, said edge length value representing a corresponding distance traveled in said indoor environment with respect to said electronic map; and
affect said motion model in estimating said trajectory of said mobile device based, at least in part, on said edge length value.

31. The mobile device as recited in claim 26, said one or more processing units to further:
obtain a second weight value for said at least one edge, said second weight value being based, at least in part, on one or more features of said electronic map within a threshold distance of said at least one edge; and
affect said decision of said motion model to transition said state along said at least one edge in estimating said trajectory of said mobile device based, at least in part, on said second weight value.

32. The mobile device as recited in claim 31, wherein said second weight value for said at least one edge based, at least in part, on one or more other weight values for at least one of said one or more neighboring nodes interconnected to said at least one node.

33. The mobile device as recited in claim 26, wherein said intersecting points of said multi-dimensional grid are uniformly distributed with regard to at least one dimension.

34. The mobile device as recited in claim 33, wherein said multi-dimensional grid comprises a two-dimensional square grid.

35. The mobile device as recited in claim 26, wherein said threshold number of edges is based on a maximum number of neighboring nodes.

36. An article for use by a mobile device, the article comprising:
a non-transitory computer readable medium having stored therein computer implementable instructions executable by one or more processing units in said mobile device to:
obtain a routability graph corresponding to an electronic map of at least a portion of an indoor environment, said routability graph specifying a predetermined number of feasible paths to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges;
obtain a weight value for at least one edge connected to said at least one node, said weight value representing a predetermined likelihood that an estimated trajectory of an object having reached said at least one node subsequently follows said at least one edge away from said at least one node; and
affect a decision of a motion model to transition a state along said at least one edge in estimating a trajectory of said mobile device based, at least in part, on said weight value.

37. The article as recited in claim 36, said computer implementable instructions being further executable to:
obtain one or more measurement values indicative of movement of said mobile device within said indoor environment; and
affect said motion model in estimating said trajectory of said mobile device based, at least in part, on said one or more measurement values.

38. The article as recited in claim 37, said computer implementable instructions being further executable to:
obtain said one or more measurement values via one or more sensors, said one or more sensors comprising at least one of: one or more communication interfaces; one or more inertial sensors; and/or one or more environmental sensors.

39. The article as recited in claim 36, said computer implementable instructions being further executable to:
obtain measurement information indicative of one or more positions of said mobile device applied to samples of a probability distribution approximated at least in part using past measurements of positions of said mobile device and/or other mobile devices within said indoor environment; and
affect said motion model in estimating said trajectory of said mobile device based, at least in part, on said measurement information.

40. The article as recited in claim 36, said computer implementable instructions being further executable to:
identify an edge length value for at least said at least one edge, said edge length value representing a corresponding distance traveled in said indoor environment with respect to said electronic map; and
affect said motion model in estimating said trajectory of said mobile device based, at least in part, on said edge length value.

41. The article as recited in claim 36, said computer implementable instructions being further executable to:
obtain a second weight value for said at least one edge, said second weight value being based, at least in part, on one or more features of said electronic map within a threshold distance of said at least one edge; and
affect said decision of said motion model to transition said state along said at least one edge in estimating said trajectory of said mobile device based, at least in part, on said second weight value.

42. The article as recited in claim 41, wherein said second weight value for said at least one edge based, at least in part, on one or more other weight values for at least one of said one or more neighboring nodes interconnected to said at least one node.

43. The article as recited in claim 36, wherein said intersecting points of said multi-dimensional grid are uniformly distributed with regard to at least one dimension.

44. The article as recited in claim 43, wherein said multi-dimensional grid comprises a two-dimensional square grid.

45. The article as recited in claim 36, wherein said threshold number of edges is based on a maximum number of neighboring nodes.

46. A method comprising, with at least one computing platform:
obtaining a routability graph corresponding to an electronic map of at least a portion of an indoor environment, said routability graph specifying a predetermined number of feasible paths for an object to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges; and
determining a weight value for at least one edge connected to said at least one node, said weight value being based, at least in part, on a likelihood that an estimated trajectory of said object having reached said at least one node subsequently follows said at least one edge away from said at least one node.

47. The method as recited in claim 46, and further comprising, with said at least one computing platform:
identifying an edge length value of at least said at least one edge, said edge length value comprising one of a predetermined number of edge length values.

48. The method as recited in claim 47, wherein each of said predetermined number of edge length values represents a corresponding distance in said indoor environment.

49. The method as recited in claim 46, and further comprising, with said at least one computing platform:
determining a second weight value for said at least one edge, said second weight value being based, at least in part, on one or more features of said electronic map within a threshold distance of said at least one edge.

50. The method as recited in claim 49, and further comprising, with said at least one computing platform:
determining said second weight value for said at least one edge based, at least in part, on one or more other weight values for at least one of said one or more neighboring nodes interconnected to said at least one node.

51. The method as recited in claim 46, wherein said intersecting points of said multi-dimensional grid are uniformly distributed with regard to at least one dimension.

52. The method as recited in claim 51, wherein said multi-dimensional grid comprises a two-dimensional square grid.

53. The method as recited in claim 46, wherein said threshold number of edges is based on a maximum number of neighboring nodes.

54. The method as recited in claim 46, and further comprising, with said at least one computing platform:
initiating transmission of at least said weight value for said at least one edge to at least one mobile device.

55. The method as recited in claim 46, wherein said at least one computing platform is provided in a mobile device.

56. An apparatus comprising:
means for obtaining a routability graph corresponding to an electronic map of at least a portion of an indoor environment, said routability graph specifying a predetermined number of feasible paths for an object to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges; and
means for determining a weight value for at least one edge connected to said at least one node, said weight value being based, at least in part, on a likelihood that an estimated trajectory of said object having reached said at least one node subsequently follows said at least one edge away from said at least one node.

57. The apparatus as recited in claim 56, and further comprising:
means for identifying an edge length value of at least said at least one edge, said edge length value comprising one of a predetermined number of edge length values.

58. The apparatus as recited in claim 56, and further comprising:
means for determining a second weight value for said at least one edge, said second weight value being based, at least in part, on one or more features of said electronic map within a threshold distance of said at least one edge.

59. The apparatus as recited in claim 58, and further comprising:
means for determining said second weight value for said at least one edge based, at least in part, on one or more other weight values for at least one of said one or more neighboring nodes interconnected to said at least one node.

60. The apparatus as recited in claim 56, and further comprising:
means for transmitting at least said weight value for said at least one edge to at least one mobile device.

61. The apparatus as recited in claim 56, wherein said apparatus is provided in a mobile device.

62. A device comprising:
memory; and
one or more processing units to:
obtain a routability graph corresponding to an electronic map of at least a portion of an indoor environment, said routability graph specifying a predetermined number of feasible paths for an object to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges; and
determine a weight value for at least one edge connected to said at least one node, said weight value being based, at least in part, on a likelihood that an estimated trajectory of said object having reached said at least one node subsequently follows said at least one edge away from said at least one node.

63. The device as recited in claim 62, said one or more processing units to further:
identify an edge length value of at least said at least one edge, said edge length value comprising one of a predetermined number of edge length values.

64. The device as recited in claim 62, said one or more processing units to further:
determine a second weight value for said at least one edge, said second weight value being based, at least in part, on one or more features of said electronic map within a threshold distance of said at least one edge.

65. The device as recited in claim 64, said one or more processing units to further:
determine said second weight value for said at least one edge based, at least in part, on one or more other weight values for at least one of said one or more neighboring nodes interconnected to said at least one node.

66. The device as recited in claim 62, and further comprising:
a communication interface; and
wherein said one or more processing units to further:
initiate transmission of at least said weight value for said at least one edge to at least one mobile device via said communication interface.

67. The device as recited in claim 62, wherein said device comprises a mobile device.

68. An article for use in at least one computing device, the article comprising:
a non-transitory computer readable medium having stored therein computer implementable instructions executable by one or more processing units of a computing platform to:
obtain a routability graph corresponding to an electronic map of at least a portion of an indoor environment, said routability graph specifying a predetermined number of feasible paths for an object to follow within said portion of said indoor environment, wherein at least one of said predetermined number of feasible paths is defined as passing through at least one of a plurality of nodes arranged at intersecting points of a multi-dimensional grid, and each of said plurality of nodes is interconnected to one or more neighboring nodes via at least one but no more than a threshold number of edges; and
determine a weight value for at least one edge connected to said at least one node, said weight value being based, at least in part, on a likelihood that an estimated trajectory of said object having reached said at least one node subsequently follows said at least one edge away from said at least one node.

69. The article as recited in claim 68, said computer implementable instructions being further executable to:
identify an edge length value of at least said at least one edge, said edge length value comprising one of a predetermined number of edge length values.

70. The article as recited in claim 68, said computer implementable instructions being further executable to:
determine a second weight value for said at least one edge, said second weight value being based, at least in part, on one or more features of said electronic map within a threshold distance of said at least one edge.

71. The article as recited in claim 70, said computer implementable instructions being further executable to:
determine said second weight value for said at least one edge based, at least in part, on one or more other weight values for at least one of said one or more neighboring nodes interconnected to said at least one node.

72. The article as recited in claim 68, said computer implementable instructions being further executable to:
initiate transmission of at least said weight value for said at least one edge to at least one mobile device.

73. The article as recited in claim 68, wherein said computing platform is provided in a mobile device.

74. A method comprising, with at least one computing platform:
determining one or more feasible paths in a routability graph corresponding to an electronic map for an indoor environment, the routability graph representing a two-dimensional grid comprising edges connecting nodes at angles selected from a predetermined set of discrete angles relative to a datum; and
selectively estimating a trajectory of a mobile device along said one or more feasible paths based, at least in part, on a sequence of measurements indicative of one or more positions of said device applied to samples of a probability distribution approximated at least in part using past measurements of positions of devices in said indoor environment.

75. The method as recited in claim 74, wherein edge length values of said edges are selected from a predetermined set of lengths.

76. The method as recited in claim 74, wherein said set of discrete angles are provided in 45 degree increments.

77. The method as recited in claim 74, wherein said nodes connected by said edges are arranged at intersecting points in a square grid.

78. The method as recited in claim 74, wherein said set of discrete angles comprises integer multiples of a discrete sub-angle.

79. The method as recited in claim 78, wherein said discrete sub-angle is 45 degrees.

80. An apparatus comprising:
means for determining one or more feasible paths in a routability graph corresponding to an electronic map for an indoor environment, the routability graph representing a two-dimensional grid comprising edges connecting nodes at angles selected from a predetermined set of discrete angles relative to a datum; and
means for selectively estimating a trajectory of a mobile device along said one or more feasible paths based, at least in part, on a sequence of measurements indicative of one or more positions of said device applied to samples of a probability distribution approximated at least in part using past measurements of positions of devices in said indoor environment.

81. A mobile device comprising:
one or more processing units to:
determine one or more feasible paths in a routability graph corresponding to an electronic map for an indoor environment, the routability graph representing a two-dimensional grid comprising edges connecting nodes at angles selected from a predetermined set of discrete angles relative to a datum; and
selectively estimate a trajectory of a mobile device along said one or more feasible paths based, at least in part, on a sequence of measurements indicative of one or more positions of said device applied to samples of a probability distribution approximated at least in part using past measurements of positions of devices in said indoor environment.

82. An article comprising:
a non-transitory computer readable medium having stored therein computer implementable instructions that are executable by one or more processing units in a computing platform to:
determine one or more feasible paths in a routability graph corresponding to an electronic map for an indoor environment, the routability graph representing a two-dimensional grid comprising edges connecting nodes at angles selected from a predetermined set of discrete angles relative to a datum; and
selectively estimate a trajectory of a mobile device along said one or more feasible paths based, at least in part, on a sequence of measurements indicative of one or more positions of said device applied to samples of a probability distribution approximated at least in part using past measurements of positions of devices in said indoor environment.
